(19) United States
(12) Patent Application Publication
(10) Pub. No.: US 2015/0311722 A1
(43) Pub. Date: Oct. 29, 2015

(54) RESOURCE MANAGEMENT METHOD AND SYSTEM WITH CLUSTERING BASED ON ATTRIBUTES OF DISTRIBUTED ENERGY RESOURCES

(71) Applicant: KOREA ELECTRONICS TECHNOLOGY INSTITUTE, Seongnam-si (KR)

(72) Inventors: Kyung Sun HAM, Yongin-si (KR); Tae Hyoung KIM, Seongnam-si (KR)

(21) Appl. No.: 14/683,603

(22) Filed: Apr. 10, 2015

(30) Foreign Application Priority Data
Apr. 25, 2014 (KR) 10-2014-0049975

(51) Int. Cl. H02J 4/00; G05B 15/02

(52) U.S. Cl. CPC H02J 4/00; G05B 15/02

(57) ABSTRACT

Provided herein is an energy resource management method and system, the method including registering energy resources; clustering the registered energy resources, and generating a plurality of resource groups; granting priorities of the resource groups; and operating the resource groups according to the priorities, thereby reducing an operation load occurring in proportionate to a quantitative increase and complexity and diversity increase of the resources, enabling efficient and economical management of the distributed energy resources.

### CROSS-REFERENCE TO RELATED APPLICATIONS

This application claims priority from Korean Patent Application No. 10-2014-0049975 filed in the Korean Intellectual Property Office on Apr. 25, 2014, the disclosure of which is incorporated herein by reference.

### TECHNICAL FIELD

Methods and apparatuses consistent with the exemplary embodiments relate to a resource management method and system, and more particularly, to a method and system for effectively managing energy resources scattered in a power plant site.

### BACKGROUND

Distributed energy resources refer to numerous energy resources (power plant facilities) distributed in a power plant site. Not only are the energy resources increasing in terms of quantity but also the types of the energy resources are becoming increasingly complex and diverse due to growing support for distributed energy resources.

Furthermore, the increase in diversity is becoming a burden to integrated management of distributed energy resources. That is, a lot of load occurs in integrating and managing distributed energy resources, making it difficult to manage distributed energy resources in a timely and appropriate manner.

Accordingly, efficient and economical management of distributed energy resources is becoming less attainable.

### SUMMARY

Therefore, a purpose of various embodiments of the present disclosure is to resolve the aforementioned problems, that is, to provide a method for clustering similar resources based on the attributes of energy resources, and granting a priority to the resources to manage the resources in units of clustered resource groups and a system thereof.

According to an embodiment of the present disclosure, there is provided an energy resource management method including registering energy resources; clustering the registered energy resources, and generating a plurality of resource groups; granting priorities of the resource groups; and operating the resource groups according to the priorities.

The energy resources may be power plant facilities distributed in one power plant site.

The generating a plurality of resource groups may cluster the energy resources based on attributes of the energy resources.

The attributes may comprise at least one of a power generation type, life span, power generation capacity, power, load capacity, average load factor, load profile, fuel cost, fuel efficiency, contract period, annual operation time, reliability and responsiveness.

The priorities may be changed based on at least one of a power generation efficiency and residual operation time.

The power generation efficiency may be changed according to a period.

The operating may determine priorities of energy resources included in the resource groups in consideration of at least one of a power generation efficiency, residual operation time, reliability, and responsiveness of the energy resources, and operate the resource groups.

According to another embodiment of the present disclosure, there is provided an energy resource management system including a registration unit configured to register energy resources; a generation unit configured to cluster the registered energy resources, and generate a plurality of resource groups; a management unit configured to grant priorities of the resource groups; and an operation unit configured to operate the resource groups according to the priorities.

As aforementioned, according to various embodiments of the present disclosure, it is possible to reduce the operation load that occurs in proportionate to the quantitative increase and complexity and diversity increase, thereby realizing efficient and economical management of the distributed energy resources.

Accordingly, it is possible to expect profits caused by integrated management of distributed energy resources, and an effect of reducing O&M costs by managing the fatigue and durability of the distributed energy resources.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram of an integrated resource management system according to an embodiment of the present disclosure;

FIG. 2 is a view for explaining an elevating method and circular list format management; and

FIG. 3 is a flowchart for explaining an integrated resource management method according to another embodiment of the present disclosure.

### DETAILED DESCRIPTION OF EXEMPLARY EMBODIMENTS OF THE INVENTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

Hereinafter, the present disclosure will be explained in more detail with reference to the figures.

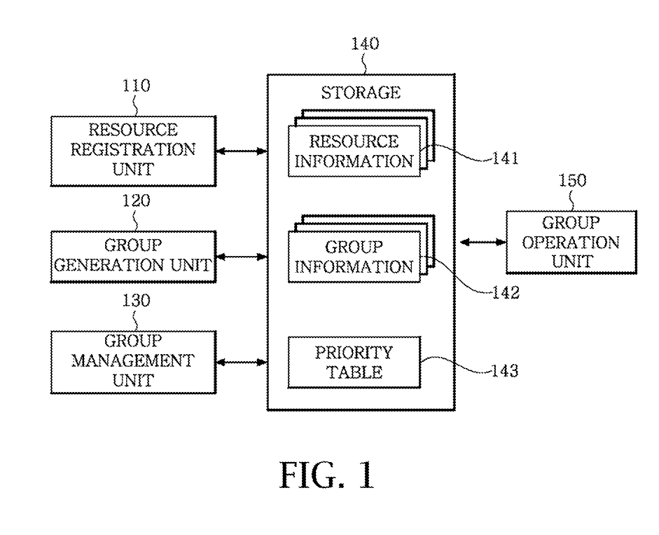

FIG. 1 is a block diagram of an integrated resource management (IRMGT) system according to an embodiment of the present disclosure. The illustrated integrated resource management system is a system for grouping energy resources (power plant facilities) distributed in a power plant site and managing/operating the same.

The integrated resource management system according to the embodiment of the present disclosure that performs such a function includes a resource registration unit 110, group generation unit 120, group management unit 130, storage 140, and group operation unit 150.

The resource registration unit 110 registers resources scattered around a power plant site that is under the control of the integrated resource management system to the storage 140. By the resource registration unit 110, resource information 141 is generated in the storage 140.

The group generation unit 120 clusters the resources registered by the resource registration unit 110 and forms a plurality of resource groups. Information on the resource groups generated by the group generation unit 120 is stored in the storage 140 as group information 142.

The group generation unit 120 clusters the energy resources based on information on attributes such as the power generation type, life span, power generation capacity, power, load capacity, average load factor, load profile, fuel costs, contract period, annual operation time, reliability, and responsiveness and so forth.

Resources having similar attributes are incorporated in a same group by the group generation unit 120.

Clustering is performed by the group generation unit 120 periodically or when an event occurs. For example, the clustering is reset by time passed (winter season, summer season) or occurrence of events [load change (light load, intermediate load, and maximum load), expiration of contract period etc.].

The group management unit 130 manages priorities of the resource groups generated by the group generation unit 120. The group management unit 130 grants the priorities according to usability. Specifically, a group having a higher power generation efficiency, residual operation time, reliability, and responsiveness is granted with a higher priority, while a group having a lower power generation efficiency, residual operation time, reliability, and responsiveness is granted with a lower priority.

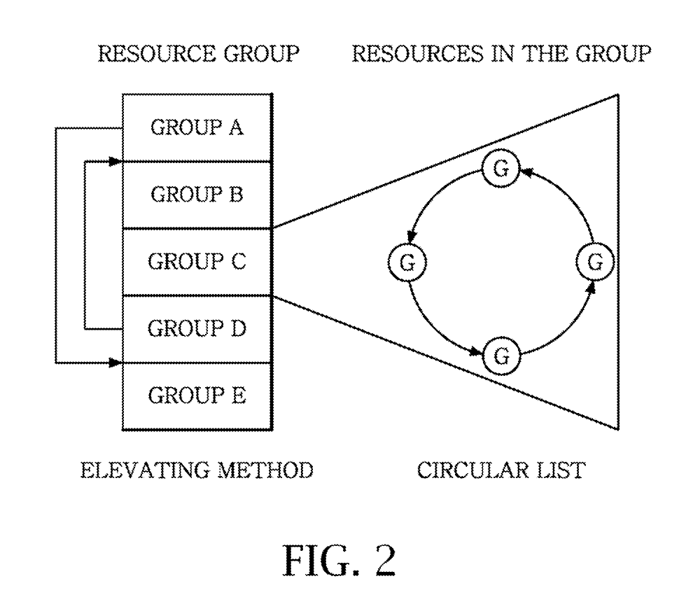

FIG. 2 illustrates a result of granting priorities to five resource groups (A, B, C, D, E) generated by the group generation unit 120. In FIG. 2, the higher the priority, the higher the resource groups are placed, while the lower the priority, the lower the resource groups are placed.

Meanwhile, the power generation efficiency and residual operation time differ depending on situations (for example, period) and operation. That is, in winter time, the power generation efficiency of group-A may be high, whereas in summer time, the power generation efficiency of group-B may be high. Furthermore, when the operation time of group-A passes, the residual operation time of group-A will decrease.

Accordingly, a resource group granted with the highest priority will be operated the most, and thus when the residual operation time decreases, its priority may become lower. Furthermore, a group with a lower priority will approach a time where its power generation efficiency is high, and if the residual operation time has not been reduced because it has not been operated, its priority may increase.

Thus, the group management unit 130 resets the priorities of the resource groups periodically. Specifically, the group management unit 130 uses an elevating method as that illustrated in the left side of FIG. 2 to change and manage the priorities of the resource groups on a regular basis.

The priorities managed by the group management unit 130 is stored in a priority table 143 of the storage 140.

The group operation unit 150 operates the resource groups based on the priority table 143 stored in the storage 140. Specifically, the group operation unit 150 operates the resources belonging to the groups having the highest priority, and generates power.

In a case where the priority table 143 is changed by the group management unit 130, the group that the group operation unit 150 operates changes as well accordingly.

Meanwhile, as illustrated in the right side of FIG. 2, the group operation unit 150 manages the resources belonging to the resource groups in a circular list format. Specifically, the group operation unit 150 determines the priorities of operating the resources in consideration of the power generation efficiency, residual operation time, reliability, and responsiveness and the like of the resources included in the resource group having the highest priority.

Furthermore, the group operation unit 150 selectively operates the resources according to the determined priorities, and ultimately planarizes the operation times of the entire resources. Such a planarization operation may be used as a method to reduce the loss of available resources as much as possible when distributed energy resources are excluded due to accidents or breakdown.

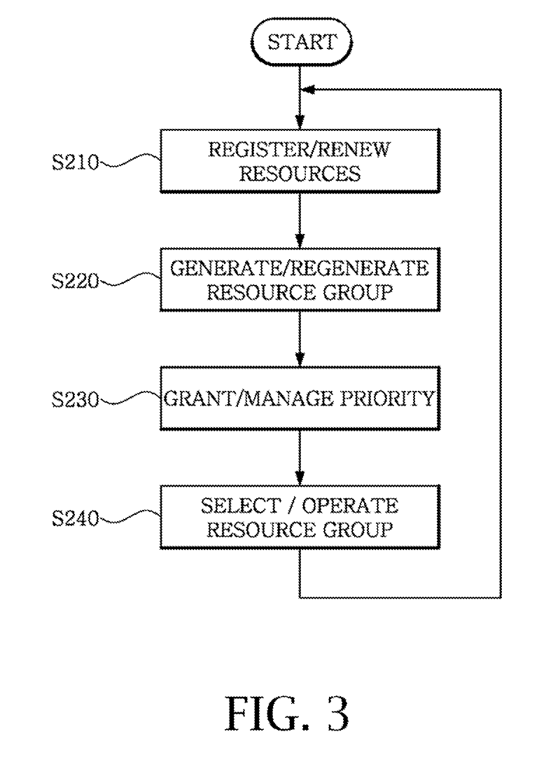

FIG. 3 is a flowchart for explaining an integrated resource management method according to another embodiment of the present disclosure.

As illustrated in FIG. 3, first of all, the resource registration unit 110 registers/renews the resources scattered around the power plant site (S210). Then, the group generation unit 120 clusters the resources registered at S210, and generates/renews a plurality of resource groups (S220).

At S220, the group generation unit 120 clusters resources having similar attributes in a same group based on attribute information such as the power generation type, life span, power generation capacity, power, load capacity, average load factor, load profile, fuel costs, fuel efficiency, contract period, annual operation time, reliability, and responsiveness and so forth.

Next, the group management unit 130 grants/manages the priorities of the resource groups generated/regenerated at S220. At S230, a group having a higher power generation efficiency, residual operation time, reliability and responsiveness is granted with a higher priority, while a group having a lower power generation efficiency, residual operation time, reliability and responsiveness is granted with a lower priority.

Next, the group operation unit 150 selects/operates the resource groups based on the priorities granted/managed at S230 (S240). At S240, the group operation unit 150 operates the resources belonging to the group having the highest priority, and generates power.

Meanwhile, at S240, the group operation unit 150 determines the priorities for the resources in consideration of the power generation efficiency, residual operation time, reliability, and responsiveness and so forth of the resources included in the resource groups, and selectively operates the resources accordingly.

Meanwhile, an SW for performing an integrated resource management method as illustrated in FIG. 3 performs as a background when operating a VPP (Virtual Power Plant) platform, and a block for optimizing resource scheduling and assuming costs per resource receives information on the groups and resource list managed by IRMGT, and utilizes the same.

Furthermore, the distributed energy resources may not only be homogeneous resources but also heterogeneous resources, and the technological concept of the present disclosure may be applied to both cases.

Although a few embodiments of the present disclosure have been shown and described, it would be appreciated by those skilled in the art that changes may be made in this embodiment without departing from the principles and spirit of the invention, the scope of which is defined in the claims and their equivalents.

What is claimed is:

1. An energy resource management method comprising:
registering energy resources;
clustering the registered energy resources, and generating a plurality of resource groups;
granting priorities of the resource groups; and
operating the resource groups according to the priorities.

2. The method according to claim 1,
wherein the energy resources are power plant distributed in one power plant site.

3. The method according to claim 1,
wherein the generating a plurality of resource groups clusters the energy resources based on attributes of the energy resources.

4. The method according to claim 3,
wherein the attributes comprise at least one of a power generation type, life span, power generation capacity, power, load capacity, average load factor, load profile, fuel cost, fuel efficiency, contract period, annual operation time, reliability and responsiveness.

5. The method according to claim 1,
wherein the priorities are changed based on at least one of a power generation efficiency and residual operation time.

6. The method according to claim 5,
wherein the power generation efficiency is changed according to a period.

7. The method according to claim 1,
wherein the operating determines priorities of energy resources included in the resource groups in consideration of at least one of a power generation efficiency, residual operation time, reliability, and responsiveness of the energy resources, and operates the resource groups.

8. An energy resource management system comprising:
a registration unit configured to register energy resources;
a generation unit configured to cluster the registered energy resources, and generate a plurality of resource groups;
a management unit configured to grant priorities of the resource groups; and
an operation unit configured to operate the resource groups according to the priorities.
